(19) United States
(12) Patent Application Publication
(10) Pub. No.: US 2005/0190163 A1
(43) Pub. Date: Sep. 1, 2005

(54) Electronic device and method of operating electronic device

(76) Inventors: Marko Sarasmo, Oulu (FI); Alpo Karjalainen, Oulu (FI); Tommi Tyyska, Oulu (FI)

Correspondence Address: CRAWFORD MAUNU PLLC, 1270 NORTHLAND DRIVE, SUITE 390, ST. PAUL, MN, 55120, US

(21) Appl. No.: 10/788,595

(22) Filed: Feb. 27, 2004

(51) Int. Cl. G09G 5/08

(52) U.S. Cl. 345/179

(57) ABSTRACT

A method of operating a stylus engagable electronic device and an electronic device are provided. The device comprises a display, a stylus holder, the holder comprising an inside surface, movement detection sensors on the inside surface of the stylus holder to detect movements of a stylus inside the stylus holder, and a processor to execute user interface commands on the basis of the detection.

### FIELD

The invention relates to a stylus engagable electronic device and to a method of enhancing user interface of the device.

### BACKGROUND

Computing devices of different kind have became more common recent years. As the technology has advanced the size of various computing devices has decreased. Mobility has increased the usability of the devices and the customers have learned to expect versatile functionality from new devices put into the market.

The advanced technology has enabled to greatly increase the computing power of electronic device. However, the mobility the customers expect from modern computing devices places large demands on the size of the devices. The small size of the devices limits the size of the user interface, such as keyboard and display. However, the users want same kind of operability from small hand held devices as they get from tabletop computers.

Various solutions have been presented to increase the usability of hand held devices, such as mobile phones, personal digital assistants (PDA) or other computing devices. As it is difficult to realize a keyboard in a handheld device, other input methods have been devised. One such solution is to use a touch sensitive screen as a display element of an electronic device. The user of the device touch objects displayed on the screen and the device is configured to detect the touch and response with a determined action. To increase the usability of the touch screen, a stylus with a relatively sharp point is often used to touch the screen. In addition, only a small keyboard or a set of buttons is often needed on the housing of the device to implement a working user interface. The device is often implemented with a stylus holder, where the stylus ia stored when not in use.

While the touch screen has increased the usability of hand held electronic devices the user interface is still cumbersome. Especially if size of the device is small and thus the size of the screen is limited, it may be difficult to show large images or web pages, for example, on a small screen. The display area of the screen has to be implemented with scroll bars so that the user may scroll the view displayed on the screen. The use of such scroll bars is cumbersome as the size of the scroll bars must be kept minimum in order so that as large views as possible may be displayed on the screen at the same time.

### BRIEF DESCRIPTION OF THE INVENTION

An object of the invention is to provide an improved user interface to electronic devices. According to an aspect of the invention, there is provided a method of operating a stylus engagable electronic device comprising a screen, and a stylus holder, the method comprising: detecting movements of a stylus inside the stylus holder; executing user interface commands on the basis of the detection.

According to another aspect of the invention, there is provided an electronic device, comprising a display and a stylus holder, and means to detect movements of a stylus inside the stylus holder, and means to execute user interface commands on the basis of the detection.

According to yet another aspect of the invention, there is provided an electronic device, comprising: a display; a stylus holder, the holder comprising an inside surface; movement detection sensors on the inside surface of the stylus holder to detect movements of a stylus inside the stylus holder; and a processor to execute user interface commands on the basis of the detection.

The solution of the invention provides several advantages. Input efficiency and usability of the electronic device is increased. When a stylus is usually operated according to prior art it is in user's hand and the user uses the stylus to give commands to the device by touching the touch screen of the device with the tip of the stylus. When the stylus is not in use it is placed in a stylus holder integrated in the housing of the device. In an embodiment of the invention, the stylus, which is placed in a stylus holder of the device, is used for giving commands to the device. The stylus may be rotated and also moved in the longitudinal direction back and forth. The commands associated with the movement may be for example scrolling the screen in vertical and horizontal directions. The rolling of the stylus in the stylus holder may scroll the view on the screen of the device in vertical direction and the back and forth direction may be associated with horizontal scrolling of the view.

### LIST OF DRAWINGS

In the following, the invention will be described in greater detail with reference to the embodiments and the accompanying drawings, in which

FIG. 1 illustrates an electronic device;

FIGS. 2A, 2B and 2C illustrate examples of sensors;

FIGS. 3A and 3B illustrate the embodiments of the invention with flowcharts and,

FIG. 4 illustrates the structure of an electronic device with a block diagram.

### DESCRIPTION OF EMBODIMENTS

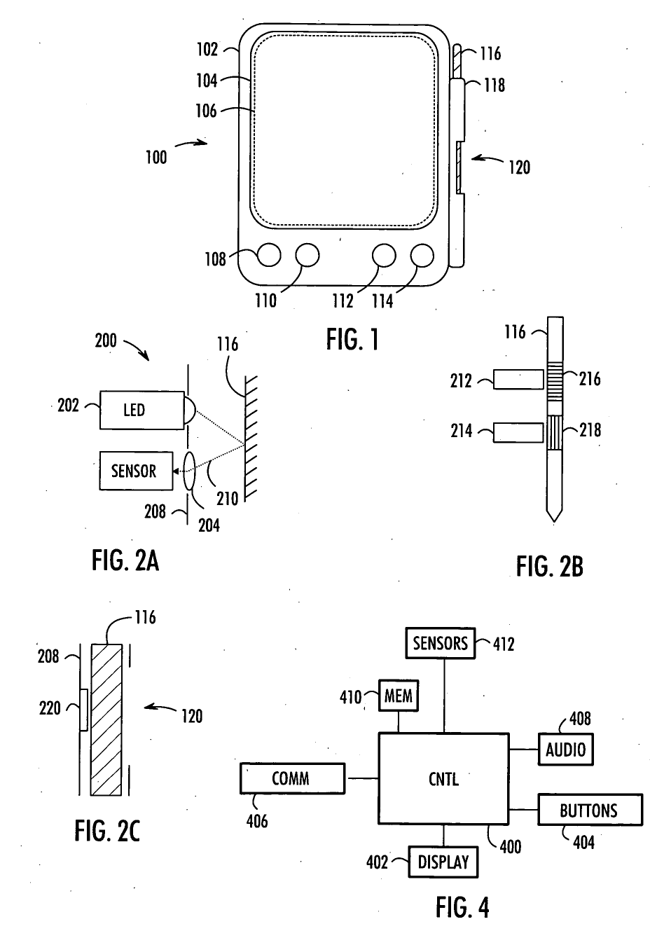

FIG. 1 illustrates an exemplary electronic device of an embodiment of the invention. The electronic device 100 includes a housing 102 and a display 104 which typically comprises a touch screen 106. One or more buttons 108 to 114 are provided with which a user may interact with the device. The device further includes a stylus 116 which may be used to access the touch screen and a stylus holder 118 where the stylus 116 may be placed when it is not used to access the touch screen.

In the example of FIG. 1, the stylus holder is on the right side of housing of the device. The place of the stylus holder may vary from device to device. In some devices the stylus holder may be on different sides of the housing. In the example embodiment of FIG. 1 the holder is visible, but the stylus holder may also be integrated into the housing. In some embodiments the housing may comprise more than one stylus holders.

In an embodiment, a user of the device may give commands to the device by moving the stylus if the stylus holder. In the example embodiment of FIG. 1, the stylus holder 118 comprises an opening 120 revealing a section of the stylus 116 inside the stylus holder. The user may access the stylus 116 inside the stylus holder 118 via the opening 120. For example, the user may rotate the stylus around the longitudinal axis of the stylus inside the stylus holder. The user may also move the stylus up and down or back and forth inside the stylus holder. The stylus may also be accessed from the tip of the stylus visible outside the stylus holder.

The electronic device comprises means to detect movements of a stylus inside the stylus holder. In an embodiment the device comprises movement detection sensor arrangement on the inside surface of the stylus holder to detect movements of a stylus inside the stylus holder. The movement detection sensor may be realized in various ways.

In an embodiment, the movement detection sensors detect the movements of the stylus optically. FIG. 2A illustrates an embodiment of the sensor arrangement 200. The arrangement comprises a light source 202, a lens 204 and an optical sensor 206 on the inside surface 208 of the stylus holder. The light source may be a light emitting diode (LED), for example. The light source emits light 210, which reflects from the surface of the stylus 116. The lens focuses the reflected light to the sensor 206. In an embodiment the sensor 206 takes periodically images from the surface of the stylus with the aid of the light emitted from the light source 202. The sensor analyses successive images and if the images are different measures the difference. From the measurement the sensor is able to detect the movements of the stylus. One example of a possible sensor is Agilent ADNS-2610 Optical Sensor. The sensor may also be realized in many other ways known for one skilled in the art.

In an embodiment, the surface of the stylus 116 has a pattern so that the sensor arrangement can more easily detect the movements of the stylus. The pattern may comprise black and white hatch pattern, and the sensor arrangement may be configured to detect the movements of the hatch pattern and determine the movement of the stylus. FIG. 2B illustrates another embodiment of the movement detection sensors. The embodiment comprises two sensor arrangements 212 and 214. Each sensor arrangement is similar in structure to the arrangement of FIG. 2A. The stylus 116 comprises two sections, first section 216 has a horizontal hatch pattern and the second section 218 comprises a vertical hatch pattern. The first sensor arrangement 212 is configured to measure the up and down movement of the stylus. Light is emitted from the light source 202 and the sensor 206 detects light pulses from the light reflected from the surface of the stylus. The hatch pattern causes a pulse effect to the reflected light. On the basis of the pulses the sensor determined the movement of the stylus. Respectively, the second sensor arrangement 214 is configured to measure the rotating movement of the stylus 116 with the aid of the horizontal hatch pattern.

In an embodiment, the movement detection sensors detect the movements of the stylus mechanically. Referring to FIG. 2B, the solution comprises two sensor arrangements 212, 214. Each arrangement comprises a roller. In arrangement 212 the roller rolls when the stylus is moved up and down. In arrangement 214 the roller rolls when the stylus is rotated.

In an embodiment, the movement detection sensors must be activated with a predetermined command. The command may be given by pressing a predetermined button of the buttons 108 to 114 on the housing of the device. The command may also be given by selecting a menu command from the touch screen.

Referring to FIG. 2C, in an embodiment, the device comprises at least one sensor 220 on the inside surface 208 of the stylus holder to detect the pressing of the stylus 116 through the opening 120 perpendicularly to the longitudinal axis of the stylus. The sensor may be a pressure sensor. This may be used in a similar manner as the buttons 108 to 114 on the housing of the device.

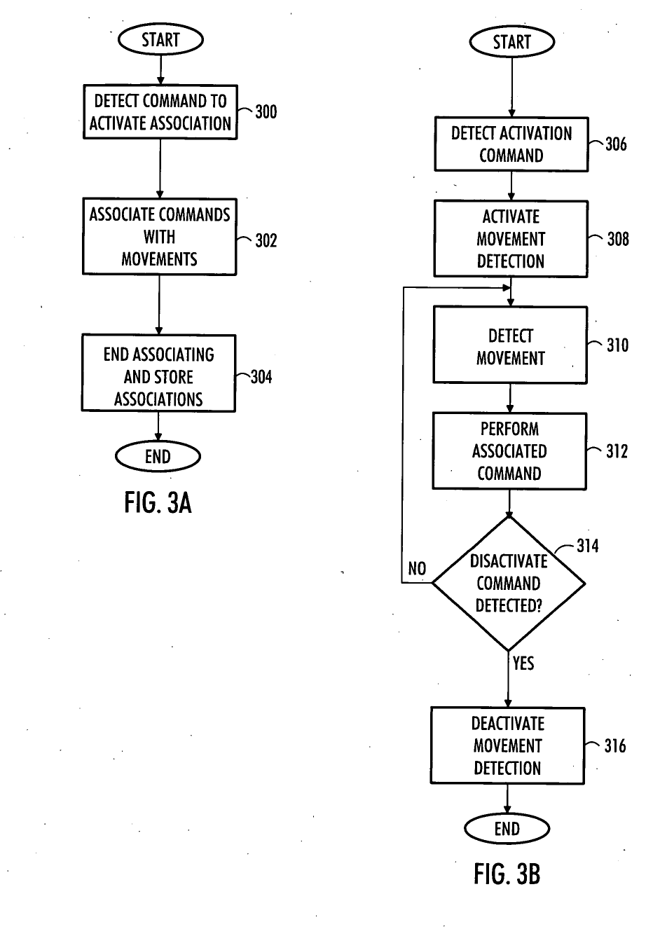

Flowcharts of FIGS. 3A and 3B illustrate an embodiment of the invention. FIG. 3A illustrates an embodiment where the different movements of the stylus are associated to different commands. In step 300 the device detects a command given by the user to activate association routine. The command may be given using a predefined button combination or by a menu command, for example.

In step 302 the different possible movements are associated with different commands. For example, the rotating of the stylus around the longitudinal axis of the stylus inside the stylus holder may be associated with scrolling the view displayed on the screen to a given direction. Respectively the up and down movement may be associated with scrolling the view to the perpendicular direction. The movements may also be associated with other commands, such as volume or brightness adjustment or cursor control, just to name few alternatives.

The movements may also be combined with button commands. Thus, pressing a given button and simultaneously rotating the stylus inside the stylus holder may be associated with a given command while rotating the stylus and pressing some other button may be associated with another command. In step 304 the device detects a command to de activate the associating. The associations are stored and the process is deactivated. Button commands may also be used simultaneously with stylus movement commands. For example, the stylus movements commands may be used to scroll a menu and a button command may be used to select a menu item.

FIG. 3B illustrates an embodiment of the movement detection. In step 306 the device detects a command given by the user to activate movement detection. The command may be given using a predefined button combination or by a menu command, for example. In step 308 the device activates the movement detection.

In step 310 the device detects the movement of the stylus inside the stylus holder in the above explained manner. In step 312 the device performs the command associated with the detected movement. In step 314 the device checks whether a command that ends the movement detection process has been detected. If this is not the case, the movement detection continues as in step 310. In case the command has been detected, the movement detection is deactivated in step 316.

FIG. 4 illustrates an example of the structure of an electronic device with a block diagram. The device comprises a processor 400 which controls the operation of the device. The processor includes suitable software. The device further comprises a display 402, which typically, but not necessarily, comprises a touch screen. The device comprises a set of buttons or a keyboard 404. In an embodiment the device comprises communication unit 406 which provides wireless communication. The communication unit may be a cellular transceiver, a short-range wireless transceiver such as Bluetooth transceiver, or a Wireless Local Area Network (WLAN) transceiver, for example. The device may comprise audio unit 408, which may include microphone and speaker. The device may store data and software applications into a memory 410.

The device comprises sensors 412 to detect the movements of a stylus inside a stylus holder. The sensors are connected to the processor. The processor detects the command to activate movement detection given by the user using the touch screen or the buttons of the device. The processor activates the detection. In an embodiment, the processor loads association table from the memory 410. The association table defines the command to be perfomrd on the basis of detected movement. The sensors 412 monitor the movements of the stylus inside the stylus holder and transmit the movement information to the processor 400. The processor executes commands on the basis of the detection information.

The functions of the processor may be realized with discrete components or signal processor, as one skilled in the art is aware.

Even though the invention is described above with reference to an example according to the accompanying drawings, it is clear that the invention is not restricted thereto but it can be modified in several ways within the scope of the appended claims.

1. A method of operating a stylus engagable electronic device comprising a screen, and a stylus holder, the method comprising:
detecting movements of a stylus inside the stylus holder,
executing user interface commands on the basis of the detection.

2. The method of claim 1, further comprising:
associating different movements of the stylus with different user interface commands.

3. The method of claim 1, further comprising: detecting
the rotating of the stylus around the longitudinal axis of the stylus inside the stylus holder and
the back and forth movement of the stylus inside the stylus holder.

4. The method of claim 1, further comprising: activating the movement detection on the basis of a predefined command detected by user interface of the device.

5. An electronic device, comprising a display and a stylus holder, and means to detect movements of a stylus inside the stylus holder, and means to execute user interface commands on the basis of the detection.

6. The device of claim 5, further comprising: processing means to associate different movements with different user interface commands.

7. An electronic device, comprising:
a display,
a stylus holder, the holder comprising an inside surface,
movement detection sensors on the inside surface of the stylus holder to detect movements of a stylus inside the stylus holder, and
a processor to execute user interface commands on the basis of the detection.

8. The device of claim 7, wherein the processor is configured to scroll the display on the basis of the detection.

9. The device of claim 7, wherein the movement detection sensors are configured
to detect the rotating of the stylus around the longitudinal axis of the stylus inside the stylus holder and
to detect the back and forth movement of the stylus inside the stylus holder.

10. The device of claim 7, further comprising means to activate the movement detection sensors.

11. The device of claim 7, further comprising: a housing, and at least one button on the housing of the device,
wherein the device is configured to detect the pressing of a button on the housing of the device.

12. The device of claim 7, wherein the electronic device comprises a housing, and the stylus holder is an elongated opening in the housing of the electronic device.

13. The device of claim 7, wherein the stylus holder comprises at least one opening through which the stylus can be accessed,
and wherein the device comprises at least one sensor on the inside surface of the stylus holder to detect the pressing of the stylus through the opening perpendicularly to the longitudinal axis of the stylus.

14. The device of claim 7, wherein the processor is configured to associate a user interface command to the pressing of the stylus and to execute the user interface command on the basis of the detection of the pressing.

15. The device of claim 7, wherein the movement detection sensors detect the movements of the stylus optically.

16. The device of claim 7, wherein the movement detection sensors detect the movements of the stylus mechanically.
